(19) United States
(12) Patent Application Publication
(10) Pub. No.: US 2013/0222179 A1
(43) Pub. Date: Aug. 29, 2013

(54) APPARATUS AND METHOD FOR ESTIMATING RAINFALL ATTENUATION, AND APPARATUS FOR COMPENSATING FOR RAINFALL ATTENUATION

(71) Applicant: Nam Ho JEONG, Chungcheongnam-do (KR)

(72) Inventor: Nam Ho JEONG, Chungcheongnam-do (KR)

(73) Assignee: ELECTRONICS AND TELECOMMUNICATIONS RESEARCH INSTITUTE, Daejeon (KR)

(21) Appl. No.: 13/557,463

(22) Filed: Jul. 25, 2012

(30) Foreign Application Priority Data
Feb. 27, 2012 (KR) 10-2012-0019893

(51) Int. Cl. H04B 7/185

(52) U.S. Cl. 342/352

(57) ABSTRACT

A rainfall attenuation estimating apparatus calculates correlation coefficients between a rainfall rate measured at a location of a satellite earth station and rainfall rates measured at locations near the satellite earth station, determines a correlation location and a correlation time difference to be used for estimating rainfall attenuation among the plurality of nearby locations based on the rainfall rates measured at the respective nearby locations and the rainfall rate measured at the location of the satellite earth station, and calculates an amount of rainfall attenuation of the satellite earth station by using rainfall rate data corresponding to a determined correlation location and correlation time difference measured at a time.

### CROSS-REFERENCE TO RELATED APPLICATION

This application claims priority to and the benefit of Korean Patent Application No. 10-2012-0019893 filed in the Korean Intellectual Property Office on Feb. 27, 2012, the entire contents of which are incorporated herein by reference.

### BACKGROUND OF THE INVENTION

(a) Field of the Invention

The present invention relates to an apparatus and method for estimating rainfall attenuation and an apparatus for compensating for rainfall attenuation and, more particularly, to an apparatus and method for estimating attenuation of radio waves caused due to rain in a communication link of a satellite communication system, and an apparatus for compensating for attenuation of radio waves.

(b) Description of the Related Art

Attenuation of a signal due to rain is considered to be one of the major factors degrading link performance in a satellite communication system. Rainfall attenuation may cause enormous damage as a frequency of satellite communication system is higher, so a technique for compensating for rainfall attenuation is very significant in terms of a tendency that satellite communication systems utilizing a high frequency band such as a Ka band, or the like, are increasing. In a satellite communication system, a technique for estimating rainfall attenuation in real time is required in order to compensate for rainfall attenuation.

In general, rainfall attenuation is estimated by analyzing dynamic characteristics such as duration, slope, and the like, of measurement data of rainfall attenuation, namely, temporal change characteristics of rainfall attenuation, at a point where an earth station is situated.

Linear interpolation, one of the simplest rainfall attenuation estimation methods, will be taken as an example. When amounts of rainfall attenuation measured at a time t₀ and a time t₁ are defined to be F(t₀) and F(t₁), respectively, the amount of rainfall attenuation at a time t may be expressed by Equation 1 shown below.

$$F ( t ) = F ( {t}_{0} ) + \frac{F ( {t}_{1} ) - F ( {t}_{0} )}{{t}_{1} - {t}_{0}} ( t - {t}_{0} ) \qquad [ Equation 1 ]$$

Here, an estimation error may be reduced when time intervals between tₒ, t₁, and t are as short as variations of the rainfall attenuation.

In this case, in estimating rainfall attenuation using temporal change characteristics of rainfall attenuation, if the temporal change characteristics of rainfall attenuation are rapidly changed, an estimation error may be increased.

### SUMMARY OF THE INVENTION

The present invention has been made in an effort to provide an apparatus and method for estimating rainfall attenuation in real time.

The present invention has also been made in an effort to provide an attenuation compensating apparatus having advantages of compensating for estimated rainfall attenuation.

An exemplary embodiment of the present invention provides an apparatus for estimating rainfall attenuation of a satellite earth station. The rainfall attenuation estimating apparatus includes: a rainfall rate measurement unit configured to measure a rainfall rate at the satellite earth station over time and measure a rainfall rate at each of locations near the satellite earth station over time; a correlation coefficient calculation unit configured to calculate correlation coefficients between the rainfall rate measured at the satellite earth station and the rainfall rates measured at the locations near the satellite earth station; a rainfall parameter determining unit configured to determine a correlation location and a correlation time difference to be used for a rainfall attenuation estimation based on the correlation coefficients between the rainfall rate measured at the satellite earth station and the rainfall rates measured at the locations near the satellite earth station; and a rainfall attenuation calculation unit configured to calculate an amount of rainfall attenuation of the satellite earth station by using rainfall rate data corresponding to a determined correlation location and correlation time difference measured at an earlier time.

The rainfall parameter determining unit may determine a time difference corresponding to correlation coefficients equal to or greater than a reference correlation coefficient among correlation coefficients between the rainfall rates measured at the locations near the satellite earth station and the rainfall rate measured at the satellite earth station, as the correlation time difference, and determine a nearby location having a time difference equal to or greater than a reference time difference among the correlation coefficients equal to or greater than the reference correlation coefficient, as the correlation location.

The correlation coefficient calculation unit may calculate correlation coefficients between the rainfall rates at the location of the satellite earth station and the rainfall rates at nearby locations for each time difference.

The reference correlation coefficient may include a maximum absolute value of a correlation coefficient calculated among a plurality of location and time difference combinations of rainfall rates.

The reference time difference may equal to or be greater than a time required for predicting the amount of rainfall attenuation and compensating for the amount of rainfall attenuation.

The rainfall rate measurement unit may include: a plurality of rain sensors configured to measure rainfall rates at the satellite earth station and at the respective locations near the satellite earth station; and a data transmission unit configured to transfer the rainfall rates measured at the satellite earth station and at the respective locations near the satellite earth station to the correlation coefficient calculation unit.

Another embodiment of the present invention provides a method for estimating rainfall attenuation of a satellite earth station by a rainfall attenuation estimating apparatus. The rainfall attenuation estimating method may include: measuring a rainfall rate at a satellite earth station over time; measuring a rainfall rate at each of locations near the satellite earth station over time; and estimating an amount of rainfall attenuation of the satellite earth station by using a time difference in a spatial correlation between the rainfall rate of the satellite earth station and the rainfall rates of the respective nearby locations.

The estimating of an amount of rainfall attenuation may include: calculating a correlation between the rainfall rate of the satellite earth station and the rainfall rates of the respective nearby locations; determining a correlation location and a correlation time difference to be used for estimating rainfall rates based on the calculated correlation coefficient; and calculating an amount of rainfall attenuation of the satellite earth station by using a rainfall rate measured at an earlier time by the correlation time difference at the correlation location.

Yet another embodiment of the present invention provides an apparatus for compensating for rainfall attenuation of a satellite earth station. The rainfall attenuation compensating apparatus includes: a rainfall attenuation estimation unit configured to estimate an amount of rainfall attenuation of the satellite earth station by using a time difference of a spatial correlation between a rainfall rate measured at the satellite earth station over time and rainfall rates measured at respective locations near the satellite earth station over time; and a compensation unit configured to compensate for the amount of rainfall attenuation of the satellite earth station.

The rainfall attenuation estimation unit may include: a correlation coefficient calculation unit configured to calculate correlation coefficients between the rainfall rate measured at the satellite earth station over time and the rainfall rates measured at the respective locations near the satellite earth station over time; a rainfall parameter determining unit configured to determine a correlation location and a correlation time difference to be used for estimating rainfall attenuation based on the correlation between the rainfall rate of the satellite earth station and the rainfall rates of the respective locations near the satellite earth station; and a rainfall attenuation calculation unit configured to calculate an amount of rainfall attenuation of the satellite earth station by using rainfall rate data corresponding to a determined correlation location and correlation time difference measured at an earlier time.

The correlation coefficient calculation unit may calculate correlation coefficients between respective rainfall rates of respective nearby locations corresponding to a plurality of time differences and the rainfall rate at the location of the satellite earth station, and the rainfall parameter determining unit may determine a time difference corresponding to correlation coefficients equal to or greater than a reference correlation coefficient among correlation coefficients between the respective rainfall rates of the nearby locations and the rainfall rate of the satellite earth station, which correspond to the plurality of time differences, as the correlation time difference, and determine a nearby location having a time difference equal to or greater than a reference time difference among the correlation coefficients equal to or greater than the reference correlation coefficient, as the correlation location.

### BRIEF DESCRIPTION OF THE DRAWINGS

FIG. 1 is a schematic block diagram of a rainfall attenuation estimating apparatus according to an embodiment of the present invention.

FIGS. 2A to 2C are views illustrating temporal distribution of rainfall rates measured by a meteorological weather radar.

FIG. 3 is a view illustrating an example of a rainfall rate measurement unit illustrated in FIG. 1.

FIG. 4 is a block diagram of a rainfall attenuation compensating apparatus according to an embodiment of present invention.

FIG. 5 is a flowchart illustrating a process of a method for estimating rainfall attenuation by the rainfall attenuation estimating apparatus according to an embodiment of present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising” will be understood to imply the inclusion of stated elements but not the exclusion of any other elements.

A rainfall attenuation estimating apparatus and method and a rainfall attenuation compensating apparatus according to embodiments of the present invention will be described in detail with reference to the accompanying drawings.

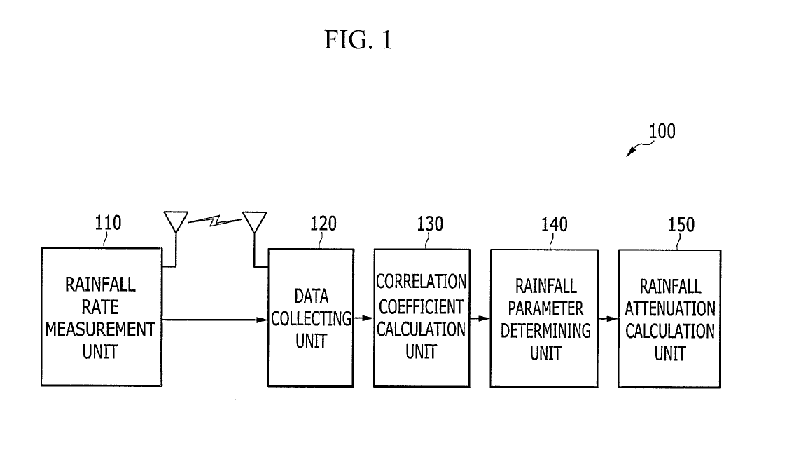

FIG. 1 is a schematic block diagram of a rainfall attenuation estimating apparatus according to an embodiment of the present invention.

Referring to FIG. 1, the rainfall attenuation estimating apparatus 100 includes a rainfall rate measurement unit 110, a data collecting unit 120, a correlation coefficient calculation unit 130, a rainfall parameter determining unit 140, and a rainfall attenuation calculation unit 150.

The rainfall rate measurement unit 110 measures rainfall rates at a plurality of locations and at a plurality of times. Here, the plurality of locations includes a location of a satellite earth station which wants to estimate rainfall attenuation, and at least one location in the vicinity of the satellite earth station.

The data collecting unit 120 receives the rainfall rate data from the rainfall rate measurement unit 110, and stores the same.

The correlation coefficient calculation unit 130 calculates correlation coefficients between the rainfall rates at the location of the satellite earth station and the rainfall rate at nearby locations for each time difference. When n number of rainfall rates measured at the nearby locations and at the location of the satellite earth station are X and Y, the correlation coefficients may be calculated as expressed by Equation 2 shown below.

$$r ( X , Y ) = \frac{{\sum }_{i = 1}^{n} ( {X}_{i} - \overline{X} ) ( {Y}_{i} - \overline{Y} )}{\sqrt{{\sum }_{i = 1}^{n} {( {X}_{i} - \overline{X} )}^{2}} \sqrt{{\sum }_{i = 1}^{n} {( {Y}_{i} - \overline{Y} )}^{2}}} \qquad [ Equation 2 ]$$

Here, X̅ and Y̅ are average values of X and Y, and as the correlation coefficient is close to ±1, it indicates high correlation, and as the correlation coefficient is close to 0, it indicates low correlation. That is, when X and Y are identical, the correlation coefficient is 1.

The rainfall parameter determining unit 140 determines a location parameter and a time difference parameter at a relevant location to be used for estimating rainfall attenuation among a plurality of nearby locations based on the correlation coefficients between the rainfall rates measured by the respective nearby locations and the location of the satellite earth station.

For example, the correlation coefficient calculation unit 130 calculates a correlation coefficient between a rainfall rate at a location ‘A’ and a rainfall rate at the location of the satellite earth station, and here, based on the rainfall rate measured at the location of the satellite earth station, the correlation coefficient calculation unit 130 140 calculates correlation coefficients between rainfall rates at the location ‘A’ corresponding to a plurality of time differences t1, t2, and t3, . . . , and the rainfall rate at the location of the satellite earth station. The rainfall parameter determining unit 140 estimates optimal time differences having an absolute value of correlation coefficient equal to or greater than a reference correlation coefficient, from the calculated correlation coefficients. In this manner, the rainfall parameter determining unit 140 estimates optimal time differences having an absolute value of correlation coefficient equal to or greater than the reference correlation coefficient for the respective nearby locations. Thereafter, the rainfall parameter determining unit 140 infers nearby locations having a time difference equal to or greater than a reference time difference from the time differences extracted from the respective nearby locations. In this case, the reference time difference may be set to be equal to or greater than a time required for predicting the amount of rainfall attenuation and compensating for rainfall attenuation. Hereinafter, the time differences and the distance from satellite earth station to corresponding nearby locations of rainfall measurement estimated by the rainfall parameter determining unit 140 will be referred to as correlation time differences and correlation positions, respectively, for the sake of convenience.

The rainfall attenuation calculation unit 150 calculates an amount of rainfall attenuation of the satellite earth station by using a rainfall rate corresponding to the correlation location and correlation time difference among the rainfall rates measured at the respective nearby locations. That is, the rainfall attenuation calculation unit 150 calculates an amount of rainfall attenuation of the satellite earth station by using rainfall measured at an earlier time by the correlation time difference among the rainfall rates measured at the correlation locations. The amount of rainfall attenuation calculated thus is used to compensate for rainfall attenuation of the satellite earth station.

In addition to the rainfall rates, the calculation of the amount of rainfall attenuation may require input parameters such as frequency, polarization, rain path length, and the like, and in an embodiment of the present invention, it is assumed that only the rainfall rate is considered.

In general, a real-time estimating apparatus of rainfall attenuation estimates rainfall attenuation by analyzing temporal change characteristics of rainfall attenuation or rainfall rates measured at the location (a single location) of the satellite earth station. However, according to an embodiment of the present invention, based on the rainfall rates measured at the respective nearby locations and the rainfall rate measured at the location of the satellite earth station, the rainfall attenuation estimating apparatus 100 estimates rainfall attenuation of the satellite earth station by using the rainfall rates measured at the nearby locations, so there is no need to analyze temporal variations of rainfall attenuation. Thus, in the present embodiment, the rainfall attenuation estimating apparatus 100 may not be affected severely by a temporal change of rainfall attenuation, and as a result, an estimation error probability can be reduced in comparison to existing rainfall attenuation estimating apparatuses using the temporal change characteristics of general rainfall attenuation in the case in which the temporal change characteristics of rainfall attenuation are rapidly changed.

Also, in the present embodiment, the rainfall attenuation estimating apparatus 100 proposes rainfall attenuation estimation of the satellite earth station in a different manner from that of existing rainfall attenuation estimation methods using the temporal change characteristics of rainfall attenuation, so one of two or both methods may be used according to the characteristics of a rain environment, thus achieving an effect of reducing an estimation error probability.

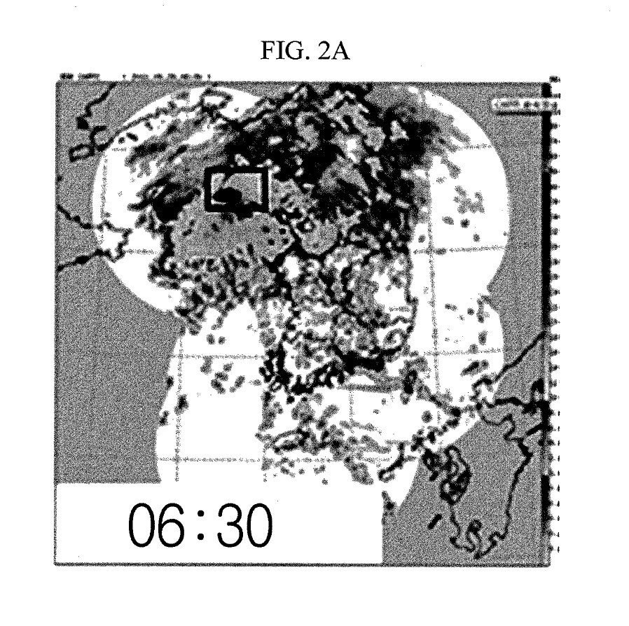

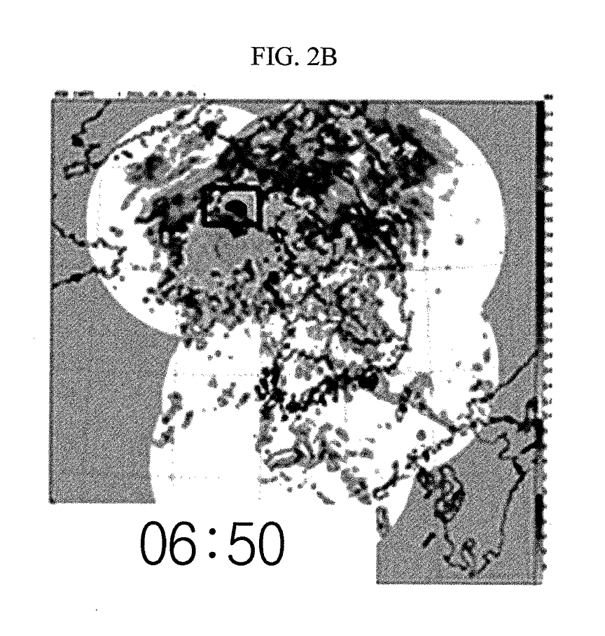

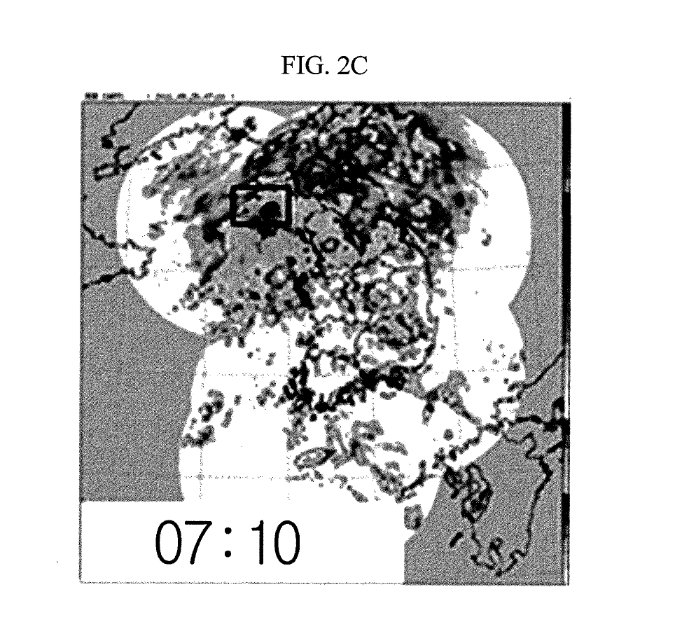

FIGS. 2A to 2C are views illustrating temporal distribution of rainfall rates measured by a meteorological weather radar.

With reference to FIGS. 2A to 2C, as indicated in the block (in black area), rain cell is formed by a certain size region similar to circular cell, and it is generally known that the size of such a rain cell is narrowed as a rainfall rate is increased. This means that rainfall rate characteristics may have a spatial correlation in a rain cell having identical rainfall rate characteristics.

Also, as can be seen from the change in the location of the rain cell in FIGS. 2A to 2C, the location of the rain cell moves from the West to the East over time due to the earth's rotation, so the spatial correlation has a time difference. Thus, as in the present embodiment, the correlation time difference according to correlation locations may be estimated by using the correlation coefficients between the rainfall rate measured at the satellite earth station and the rainfall rates measured at the nearby locations, whereby an amount of rainfall attenuation of the satellite earth station can be estimated in real time by using a rainfall rate of a nearby location corresponding to the correlation time difference according to the correlation location.

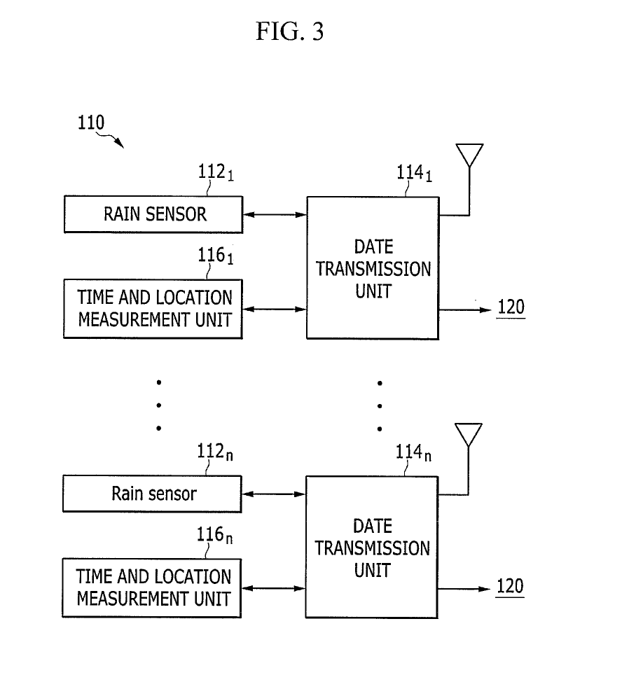

FIG. 3 is a view illustrating an example of a rainfall rate measurement unit illustrated in FIG. 1.

With reference to FIG. 3, the rainfall rate measurement unit 110 may include a plurality of rain sensors 112₁-112ₙ and a plurality of data transmission units 114₁-114ₙ. Also, the rainfall rate measurement unit 110 may further include a plurality of time and location measurement units 116₁-116ₙ.

The rain sensors 112₁-112ₙ are located at a different locations, measure a rainfall rate at the corresponding locations, and transfer the measured rainfall rate to the data transmission units 114₁-114ₙ, respectively. One of the rain sensors 112₁-112ₙ may be situated in the satellite earth station, and the remaining rain sensors may be situated at nearby locations. As the rain sensors 112₁-112ₙ, for example, a rain gage, disdrometer, or the like, may be used.

The data transmission units 114₁-114ₙ receive the rainfall rates from the corresponding rain sensors 112₁-112ₙ and transfer the received rainfall rates to the data collecting unit 120. Here, only a single data transmission unit, instead of the plurality of data transmission units, may be configured. The data transmission units 114₁-114ₙ may transfer the rainfall rates to the data collecting unit 120 through wired/wireless communication links.

The time and location measurement units 116₁-116ₙ may measure a time and/or a location at which the rainfall rates were measured by the corresponding rain sensors 112₁-112ₙ, and transfer the measured time and location to the data transmission units 114₁-114_{n.}

The rain sensors 112₁-112ₙ may transfer the time or location at which the rainfall rates were measured, as well as the rainfall rates, to the data transmission units 114₁-114ₙ, and in this case, the time and location measurement units 116₁-116ₙ of the rainfall rate measurement unit 110 may be omitted.

Also, as the rain sensors 112₁-112ₙ, rain radar may be used, and the rain radar can simultaneously measure rainfall rates at a plurality of locations. Thus, the use of the rain radar can reduce the number of rain sensors and data transmission units to be used.

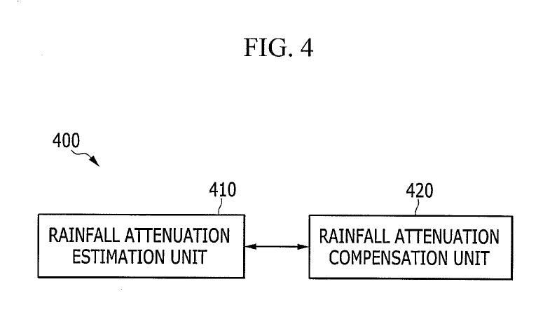

FIG. 4 is a block diagram of a rainfall attenuation compensating apparatus according to an embodiment of present invention.

With reference to FIG. 4, the rainfall attenuation compensating apparatus 400 includes a rainfall attenuation estimation unit 410 and a compensation unit 420.

The rainfall attenuation estimation unit 410 corresponds to the rainfall attenuation estimating apparatus 100 illustrated in FIG. 1, and calculates an amount of rainfall attenuation on the basis of the method as described above.

The compensation unit 420 compensates for an amount of rainfall attenuation calculated by the rainfall attenuation estimation unit 410. Methods for compensating for the amount of rainfall attenuation may include diversity receiving, adaptive error correction coding (variable transfer rate coding), power control, adaptive modulation/demodulation, and the like. The compensation unit 420 may compensate for the amount of rainfall attenuation by using at least one of the methods.

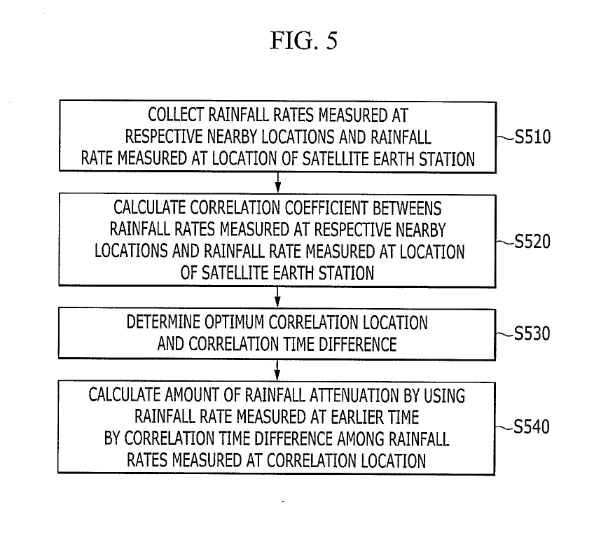

FIG. 5 is a flowchart illustrating a process of a method for estimating rainfall attenuation by the rainfall attenuation estimating apparatus according to an embodiment of present invention.

With reference to FIG. 5, a rainfall rate is measured by the rainfall rate measurement unit 110 at the satellite earth station over time. Also, rainfall rates are measured by the rainfall rate measurement unit 110 at respective nearby locations over time.

When the rainfall rates of the satellite earth station measured by the rainfall rate measurement unit 110 and the rainfall rates of the respective nearby locations are collected by the data collecting unit 120 (S510), an amount of rainfall attenuation of the satellite earth station is calculated by using the collected rainfall rates.

In detail, the correlation coefficient calculation unit 130 calculates correlation coefficients between the rainfall rates measured at the respective nearby locations and the rainfall rate measured at the satellite earth station (S520).

Based on the correlation coefficients calculated by the correlation coefficient calculation unit 130, the rainfall parameter determining unit 140 determines an optimum correlation location and a correlation time difference to be used for estimating rainfall attenuation among the plurality of nearby locations (S530). As described above, the correlation time difference refers to a time difference having an absolute correlation coefficient equal to or greater than a reference correlation coefficient among the calculated correlation coefficients, and the correlation location refers to a nearby location having a time difference equal to or greater than a reference time difference among the estimated correlation time differences.

The rainfall attenuation calculation unit 150 calculates an amount of rainfall attenuation of the satellite earth station by using a rainfall rate measured at an earlier time by the correlation time difference among the rainfall rates measured at the correlation location (S540). Then, an amount of future rainfall attenuation of the satellite earth station can be calculated by using the rainfall rate of the nearby location (correlation location) measured at the earlier time by the correlation time difference from a current time based on the satellite earth station, as it is.

According to an embodiment of the present invention, real-time rainfall attenuation estimation results required for a fade compensation technique (or apparatus) of a satellite communication system can be provided. Thus, the present invention can be advantageously utilized as an alternative to an existing method for estimating rainfall attenuation in real time.

Also, since a calculation method is different from that of an existing prediction method, improved accuracy in estimation results according to the present invention can be provided, and when the present invention is used in conjunction with the existing estimation method, an estimation error probability can be reduced.

The embodiments of the present invention may not necessarily be implemented only through the foregoing devices and/or methods but may also be implemented through a program for realizing functions corresponding to the configurations of the embodiments of the present invention, a recording medium including the program, or the like, and such an implementation may be easily made by a skilled person in the art to which the present invention pertains from the foregoing description of the embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A rainfall attenuation estimating apparatus for estimating rainfall attenuation of a satellite earth station, the apparatus comprising:
a rainfall rate measurement unit configured to measure a rainfall rate at the satellite earth station over time and measure a rainfall rate at each of locations near the satellite earth station over time;
a correlation coefficient calculation unit configured to calculate correlation coefficients between the rainfall rate measured at the satellite earth station and the rainfall rates measured at the locations near the satellite earth station;
a rainfall parameter determining unit configured to determine a correlation location and a correlation time difference to be used for a rainfall attenuation estimation based on the correlation coefficients between the rainfall rate measured at the satellite earth station and the rainfall rates measured at the locations near the satellite earth station; and
a rainfall attenuation calculation unit configured to calculate an amount of rainfall attenuation of the satellite earth station by using rainfall rate data corresponding to a determined correlation location and correlation time difference measured at an earlier time.

2. The rainfall attenuation estimating apparatus of claim 1, wherein the rainfall parameter determining unit may determine a time difference corresponding to correlation coefficients equal to or greater than a reference correlation coefficient among correlation coefficients between each rainfall rates measured at the locations near the satellite earth station and the rainfall rate measured at the satellite earth station, as the correlation time difference, and
determine a nearby location having a time difference equal to or greater than a reference time difference among the correlation coefficients equal to or greater than the reference correlation coefficient, as the correlation location.

3. The rainfall attenuation estimating apparatus of claim 1, wherein the correlation coefficient calculation unit calculates correlation coefficients between the rainfall rate at the location of the satellite earth station and the rainfall rates at nearby locations for each time difference.

4. The rainfall attenuation estimating apparatus of claim 2, wherein the reference correlation coefficient comprises a maximum correlation coefficient.

5. The rainfall attenuation estimating apparatus of claim 2, wherein the reference time difference equals to or be greater than a time required for predicting the amount of rainfall attenuation and compensating for the amount of rainfall attenuation.

6. The rainfall attenuation estimating apparatus of claim 1, wherein the rainfall rate measurement unit comprises:
a plurality of rain sensors configured to measure rainfall rates at the satellite earth station and at the respective locations near the satellite earth station; and
a data transmission unit configured to transfer the rainfall rates measured at the satellite earth station and at the respective locations near the satellite earth station to the correlation coefficient calculation unit.

7. A method for estimating rainfall attenuation of a satellite earth station by a rainfall attenuation estimating apparatus, the method comprising:
measuring a rainfall rate at a satellite earth station over time;
measuring a rainfall rate at each of locations near the satellite earth station over time; and
estimating an amount of rainfall attenuation of the satellite earth station by using a time difference in a spatial correlation between the rainfall rate of the satellite earth station and the rainfall rates of the respective nearby locations.

8. The method of claim 7, wherein the estimating of an amount of rainfall attenuation comprises:
calculating a correlation between the rainfall rate of the satellite earth station and the rainfall rates of the respective nearby locations;
determining a correlation location and a correlation time difference to be used for estimating rainfall rates based on the calculated correlation coefficient; and
calculating an amount of rainfall attenuation of the satellite earth station by using a rainfall rate measured at an earlier time by the correlation time difference at the correlation location.

9. The method of claim 8, wherein the calculating of a correlation comprises:
calculating correlation coefficients between the respective rainfall rates of the respective nearby locations corresponding to a plurality of time differences and the rainfall rate of the satellite earth station by using the rainfall rates of the respective nearby locations.

10. The method of claim 8, wherein the determining comprises:
determining a time difference corresponding to a correlation coefficient equal to or greater than a reference correlation coefficient among the correlation coefficients between the respective rainfall rates of the respective nearby locations corresponding to the plurality of time differences and the rainfall rate of the satellite earth station, as the correlation time difference; and
determining a nearby location having a time difference equal to or greater than a reference time difference among the correlation coefficients equal to or greater than the reference correlation coefficient, as the correlation location.

11. A rainfall attenuation compensating apparatus for compensating for rainfall attenuation of a satellite earth station, the apparatus comprising:
a rainfall attenuation estimation unit configured to estimate an amount of rainfall attenuation of the satellite earth station by using a time difference of a spatial correlation between a rainfall rate measured at the satellite earth station over time and rainfall rates measured at respective locations near the satellite earth station over time; and
a compensation unit configured to compensate for the amount of rainfall attenuation of the satellite earth station.

12. The rainfall attenuation compensating apparatus of claim 11, wherein the rainfall attenuation estimation unit comprises:
a correlation coefficient calculation unit configured to calculate a correlation coefficient between the rainfall rate measured at the satellite earth station over time and the rainfall rates measured at the respective locates near the satellite earth station over time;
a rainfall parameter determining unit configured to determine a correlation location and a correlation time difference to be used for estimating rainfall attenuation based on the correlation between the rainfall rate of the satellite earth station and the rainfall rates of the respective locations near the satellite earth station; and
a rainfall attenuation calculation unit configured to calculate an amount of rainfall attenuation of the satellite earth station by using a rainfall rate data corresponding to a determined correlation location and correlation time difference measured at an earlier time.

13. The rainfall attenuation compensating apparatus of claim 12, wherein the correlation coefficient calculation unit calculates a correlation coefficient between respective rainfall rates of respective nearby locations corresponding to a plurality of time differences and the rainfall rate at the location of the satellite earth station, and
the rainfall parameter determining unit determines a time difference corresponding to correlation coefficients equal to or greater than a reference correlation coefficient among correlation coefficients between the respective rainfall rates of the nearby locations and the rainfall rate of the satellite earth station, which correspond to the plurality of time differences, as the correlation time difference, and determines a nearby location having a time difference equal to or greater than a reference time difference among the correlation coefficients equal to or greater than the reference correlation coefficient, as the correlation location.

14. The rainfall attenuation compensating apparatus of claim 11, wherein the compensation unit compensates for the amount of rainfall attenuation by using at least one of diversity receiving, variable transfer rate coding, power control, and adaptive modulation/demodulation.
